(19) United States
(12) Patent Application Publication
(10) Pub. No.: US 2019/0267851 A1
(43) Pub. Date: Aug. 29, 2019

(54) ROTOR OF A ROTARY ELECTRICAL MACHINE PROVIDED WITH RARE EARTH MAGNETS WITH A LOW DYSPROSIUM CONTENT

(71) Applicant: Valeo Equipements Electriques Moteur, Creteil (FR)

(72) Inventors: Jean-Marc Dubus, Creteil (FR); Benoit Walme, Créteil (FR); Johnny Duarte, Créteil (FR); Mamy Rakotovao, Créteil (FR)

(73) Assignee: Valeo Equipements Electriques Moteur, Creteil (FR)

(21) Appl. No.: 16/310,658

(22) PCT Filed: May 19, 2017
(86) PCT No.: PCT/FR2017/051230

§ 371 Date: Dec. 17, 2018

(30) Foreign Application Priority Data
May 25, 2016 (FR) 1654692

(51) Int. Cl. H02K 1/02; H02K 1/22; C22C 38/00

(52) U.S. Cl. CPC H02K 1/02; H01F 1/057; C22C 38/005; H02K 1/226

(57) ABSTRACT

The invention mainly relates to a claw-pole rotor (2) for a rotating electric machine, characterized in that said rotor comprises a plurality of magnets (20) that are located between the poles and are made of neodymium-iron-boron having a dysprosium content of less than 2% by weight. By keeping the dysprosium content in the magnets of the rotating electric machine to a minimum, the invention thus does away with the problems associated with the limited dysprosium supplies and its cost.

The invention relates to a rotor of a rotary electrical machine provided with rare earth magnets with a low dysprosium content.

The invention has a particularly advantageous, but non-exclusive, application in the field of alternators for motor vehicles. An alternator of this type transforms mechanical energy into electrical energy, and can be reversible. A reversible alternator of this type is known as an alternator-starter and makes it possible to transform electrical energy into mechanical energy, in particular in order to start the thermal engine of the vehicle. The invention can also be implemented with an electric motor.

In a known manner, an alternator starter comprises a housing, and, inside the latter, a claw rotor fitted on a shaft, and a stator which surrounds the rotor. The stator comprises a body in the form of a set of metal plates provided with notches for fitting of the phases of the stator. Each phase comprises at least one winding which passes through the notches in the stator body, and, with all the phases, forms chignons on both sides of the stator body. The phase windings are obtained for example from a continuous wire covered with enamel or from conductive elements in the form of pins which are connected electrically to one another for example by welding.

In addition, the rotor comprises two magnet wheels which each have a flange with transverse orientation provided on its outer periphery with claws, which for example have a trapezoidal form and axial orientation. The claws of one wheel are directed axially towards the flange of the other wheel. The claws of one magnet wheel penetrate in the space which exists between two adjacent claws of the other magnet wheel, such that the claws of the magnet wheels are imbricated relative to one another,

In order to improve the magnetic performance of the electrical machine, it is known to interpose permanent magnets made of neodymium-iron-boron between two adjacent claws.

The problem with magnets of this type is that they contain a large quantity of dysprosium, which involves a high production cost, as well as supply problems, taking into account the small number of production areas of this material in the world.

The objective of the invention is to eliminate this disadvantage efficiently by proposing a claw rotor for a rotary electrical machine, characterised in that it comprises a plurality of interpolar magnets made of neodymium-iron-boron, the dysprosium content of which is less than 2% by weight.

The invention thus makes it possible, by minimising the dysprosium content in the magnets of the rotary electrical machine, to eliminate the problems associated with the fluctuation of its supply and its cost.

According to one embodiment, the dysprosium content is less than 1.8% by weight.

According to one embodiment, the dysprosium content is less than 0.03% by weight. This corresponds to the presence of impurities in the magnet derived from the neodymium.

According to one embodiment, a size of the grains of each magnet is less than 8 μm.

According to one embodiment the size of the grains of each magnet is approximately 3 μm.

According to one embodiment, a content of neodymium and praseodymium of each magnet is between 28 and 35% by weight, and is preferably 33%.

According to one embodiment, a boron content of each magnet is between 0.5 and 1.5% by weight, and is preferably 1%.

According to one embodiment, an iron content of each magnet is equal to at least 60% by weight.

According to one embodiment, a tongue covers a face of each magnet.

According to another aspect, the invention relates to a rotary electrical machine comprising a claw rotor as previously defined.

According to one embodiment, the said rotary electrical machine can operate at a voltage selected from one of the following voltages: 12 V, 14 V+X V, within the context of a floating electrical network, 48 V, or between 100 and 300 V.

According to one embodiment, the said rotary electrical machine can operate either in alternator mode, or in motor and generator mode.

The invention will be better understood by reading the following description and examining the figures which accompany it. These figures are provided purely by way of illustration, and in no way limit the invention.

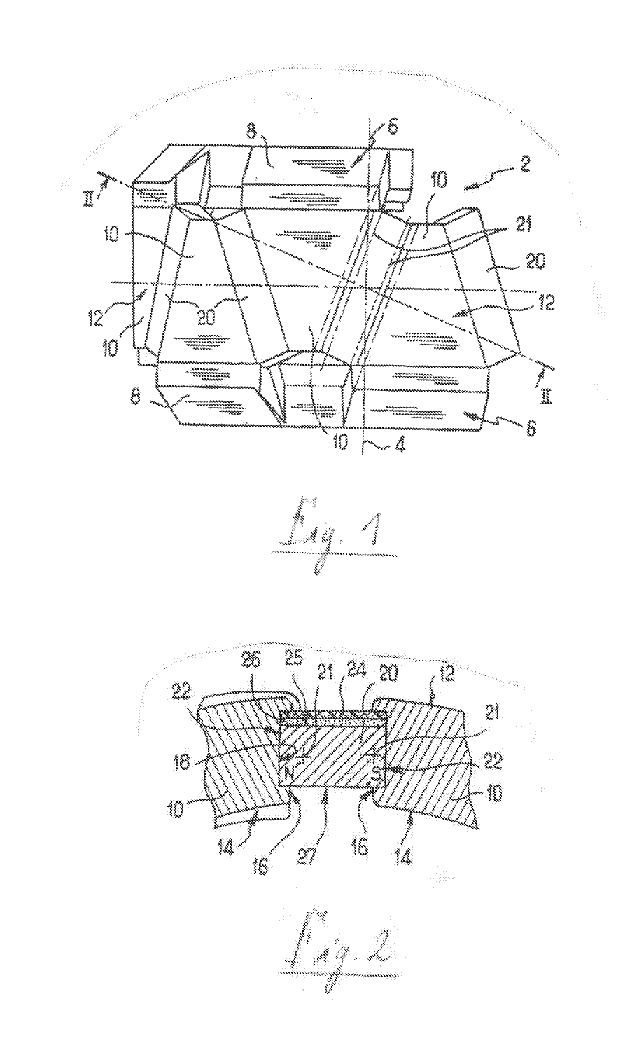

FIG. 1 is a partial view in elevation of a claw rotor of a rotary electrical machine according to the present invention;

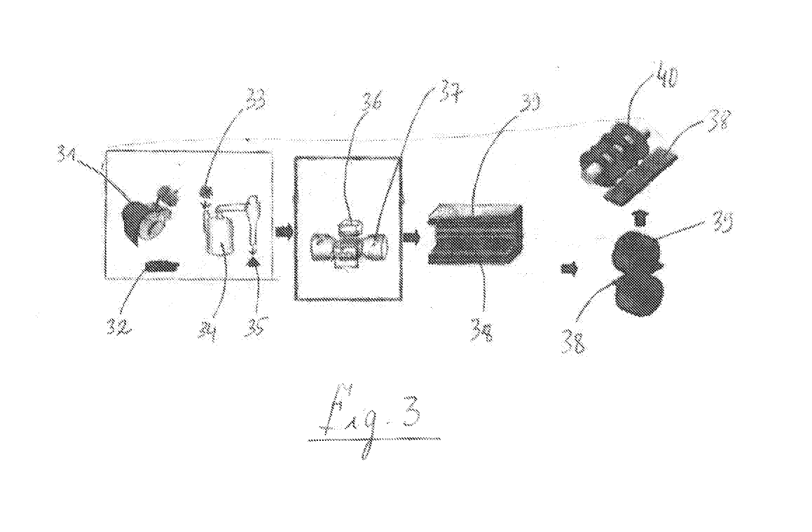

FIG. 2 is a partial view in cross-section according to the line II-II of the rotor in FIG. 1;

FIG. 3 is a schematic representation of the different steps of production of the rare earth magnets according to the invention.

Elements which are identical, similar or analogous retain the same reference from one figure to another.

The electrical machine comprises a stator and a rotor 2 provided with a shaft with an axis 4. The machine can operate either in alternator mode, or in motor and generator mode at a voltage selected from one of the following voltages: 12 V, 14 V+X V, within the context of a floating electrical network, 48 V, or between 100 and 300 V.

The rotor 2 comprises two polar parts 6 each comprising a flange 8 in the form of a disc fitted coaxially on the shaft. The two flanges 8 extend coinciding and parallel with one another.

Each polar part 6 comprises poles 10 in the form of a claw, which are generally flat and triangular, extending from the flange 8 in the direction of the other flange. The poles of the polar parts are interlaced with one another such that the tip of each pole 10 extends in the vicinity of the flange 8 of the other polar part.

The two polar parts 6 are associated with the respective North and South magnetic poles. Each pole 10 has two circumferential faces which are respectively convex outer 12 and concave inner 14, and two flat lateral faces 16 which form two of the sides of the triangle and are contiguous to the lateral faces of the circumferential poles. The faces extend opposite and spaced from one another.

Each lateral face 16 has a groove 18 or channel¹ with a profile in the form of a “LT”, the groove having an axis 21 which extends in a longitudinal direction of the lateral face 16. ¹The French text fluctuates between using reference 18 for “rainure”=“groove” and “gorge”=“channel”. The translation follows the same pattern as the original version.

The channel 18 has a flat base and two flanks perpendicular to it. The rotor 2 comprises permanent magnets 20, known as interpolar magnets, which in this case have a general form of a rectangular parallelepiped, and in particular a rectangular profile perpendicularly to a longitudinal direction of the magnet.

Each magnet 20 is received between the lateral faces 16 of two respective poles with its lateral faces 22 in the channels 18, optionally with interposition of a layer of glue at the base of the channels.

Each magnet 20 is polarised North to South in a direction extending from one to the other of its lateral faces 22.

Each pair of grooves 1 opposite one another defines a magnet receptacle 20, with the profile of the grooves preventing the magnet from coming out of the receptacle on a plane perpendicular to an axis 21 of the grooves, once the poles 10 are interlaced with one another. In order to introduce a magnet into its receptacle, or to extract it from its receptacle, it is possible for example to make it slide parallel to the axis 21 of the grooves as far as the axial end of the receptacle.

Preferably, the rotor 2 comprises for each magnet 20 a tongue 24 or small plate made of a material which is softer and more flexible the material of the magnet. In this case, use is made of glass fibres embedded in a pre-impregnated plastic material. The tongue 24 is flat, rectangular, and has the same dimensions and the same form as the outer circumferential face 25 of the magnet 20 which it covers with its coinciding edges. A layer of glue 26, which is more flexible than the magnet 20, is interposed between the magnet 20 and the tongue 24. The tongue 24 and the layer of glue 26 each extend in the two grooves 18, whilst being interposed between the circumferential outer face 25 of the magnet and one of the flanks of the groove 18. The circumferential outer face 25 of the magnet is oriented in the direction opposite the shaft of the rotor, unlike the circumferential inner thee 27 of the magnet, which is oriented towards this shaft.

Thanks to the flexibility of the tongue 24 and the layer of glue 26, in a direction which is radial relative to the axis 4 of the rotor, there is elimination of the gaps due to the production tolerances, in addition, when the rotor 5 is rotating at high speeds, there is damping of the deformations of the parts caused by the forces and the heating derived from the rotation of the rotor.

For the assembly, it is possible to glue the tongue 24 to each magnet 20, then to introduce the assembly thus constituted into its receptacle. Alternatively, it is possible to introduce each magnet 20 into its receptacle, then introduce the tongue 24 into the receptacle, and glue it to the magnet on this occasion.

According to the invention, the interpolar magnets 20 are made of neodymium-iron-boron, and have a dysprosium content of less than 2% by weight, or less than 1.8% by weight. Preferably, the dysprosium content is less than 0.03% by weight, which corresponds to the presence of impurities in the magnet derived from the neodymium.

A size of the grains of each magnet 20 is less than 8 μm, and is preferably approximately 3 μm.

A content of neodymium and praseodymium of each magnet 20 is between 28 and 35% by weight, and is preferably 33%. This content is thus to be taken into consideration relative to the sum of the weight of the neodymium and praseodymium contained in the magnet 20.

A boron content of each magnet 20 is between 0.5 and 1.5% by weight, and is preferabl 1%.

An iron content of each magnet 20 is equal to at least 60% by weight.

With reference to FIG. 3, a description is provided hereinafter of the method for production of magnets 20 of this type. After having weighed the quantity of materials necessary for the production of a series of magnets 20 in the weight proportions previously indicated, the materials are fused in an induction furnace in a controlled atmosphere containing at least 90% nitrogen. The fused material is then poured onto a rotary roller 31 in order to obtain petals of material 32.

Grains 33 with a diameter of approximately 100 μm are then introduced into a crushing device 34 with a nitrogen jet in order to obtain a powder 35 containing grains of approximately 3 μm.

A mould 36 then ensures compacting of the powder 35, in order to obtain a block 38. The compacting is carried out under a magnetic field applied by electromagnets 37. The magnetic field can be oriented according to the direction of the application of the pressing force, or according to a direction perpendicular to the pressing force.

After the compacting step, the block 38 is introduced into a furnace 39 in order to ensure its firing, as well as a thermal post-treatment.

It should be noted that the steps of obtaining the petals 32, crushing by a nitrogen jet, compacting, and firing are carried out in a controlled atmosphere with the presence of nitrogen at more than 90%. This makes it possible to avoid oxygenation of the magnets 20 as far as possible.

The block 38 is then machined in order to be formed, and obtain the required tolerances by means of an appropriate device 39. The block 38 is then cut by means of a tool 40 in order to obtain a plurality of individual magnets 20, it will also be possible to implemnt a step of surface treatment of the magnets 20 in order to protect them against corrosion,

It will be appreciated that the foregoing description has been provided purely by way of example, and does not limit the field of the invention, a departure from which would not be constituted by replacing the different elements by any other equivalents.

1. A claw rotor for a rotary electrical machine, comprising:
a plurality of interpolar magnets made of neodymium-iron-boron, the dysprosium content of which is less than 2% by weight.

2. The claw rotor according to claim 1, wherein the dysprosium content is less than 1.8% by weight.

3. The claw rotor according to claim 1, wherein the dysprosium content is less than 0.03% by weight.

4. The claw rotor according to claim 3, wherein a size of the grains of each magnet is less than 8 μm.

5. The claw rotor according to claim 4, wherein the size of the grains of each magnet is approximately 3 μm.

6. The claw rotor according to claim 1, wherein a content of neodymium and praseodymium of each magnet is between 28 and 35% by weight.

7. The claw rotor according to claim 1, wherein a boron content of each magnet is between 0.5 and 1.5% by weight.

8. The claw rotor according to claim 1, wherein an iron content of each magnet is equal to at least 60% by weight.

9. The claw rotor according to claim 1, wherein a tongue covers a face of each magnet.

10. A rotary electrical machine comprising a claw rotor as defined according to claim 1.

11. The rotary electrical machine according to claim 10, wherein the rotary electrical machine operates at a voltage selected from one of the following voltages; 12 V, 14 V+X V, within the context of a floating electrical network, 48 V, or between 100 and 300 V.

12. The rotary electrical machine according to claim 10, wherein the rotary electrical machine operates either in alternator mode, or in motor and generator mode.
